(19) United States
(12) Patent Application Publication
(10) Pub. No.: US 2025/0251808 A1
(43) Pub. Date: Aug. 7, 2025

(54) In-Cell Touch Display Device

(71) Applicant: LG Display Co., Ltd., Seoul (KR)

(72) Inventor: Cheolse Kim, Gapyeong-gun (KR)

(21) Appl. No.: 18/942,067

(22) Filed: Nov. 8, 2024

(30) Foreign Application Priority Data
Feb. 6, 2024 (KR) 10-2024-0018258

(51) Int. Cl. G06F 3/041

(52) U.S. Cl. CPC G06F 3/0412; G06F 3/04164

(57) ABSTRACT

The present disclosure provides an in-cell touch display device in which an in-cell touch sensor technology can be implemented in an organic light emitting diode display panel. An in-cell touch display device may include a substrate, a transistor formation layer formed on the substrate and including a semiconductor, a source electrode, a drain electrode, and a gate electrode, and a light emitting element layer formed on the transistor formation layer and including an anode electrode, an emission layer, and a cathode electrode, and wherein a plurality of touch electrodes forming a coupling capacitor with the cathode electrode of the light emitting element layer may be formed in the transistor formation layer.

### CROSS REFERENCE TO RELATED APPLICATION

The present application claims priority to Republic of Korea Patent Application No. 10-2024-0018258, filed on Feb. 6, 2024, which is hereby incorporated by reference in its entirety.

### BACKGROUND

### Field of Technology

The present disclosure relates to an in-cell touch display device.

### Description of the Related Art

As the information society develops, various types of display devices for displaying images are being developed. In addition, the development of a touch technology for applying a touch-based input method of allowing users to easily, intuitively, and conveniently input information or a command to the display device.

As described above, to apply the touch-based input method to the display device, a touch panel including a touch sensor should be separately manufactured and coupled to a display panel. The method has a disadvantage of increasing the size or thickness of the device and complicating a manufacturing process. Therefore, an in-cell touch sensor technology in which the touch sensor is embedded in the display panel is being developed without separately manufacturing the touch panel.

### SUMMARY

A technology having a considerable technical difficulty is to design and manufacture a display panel in which a touch sensor is embedded. In addition, when the touch sensor including a plurality of touch electrodes is embedded in the display panel, since the touch sensor may be located very close to a display driving electrode or a display driving line inside the display panel, the possibility that a parasitic capacitance between the touch sensor and the display driving electrode or a parasitic capacitance between the touch sensor and the display driving line increases can be increased significantly, and an increase in the parasitic capacitance may lead to the degradation of touch sensitivity.

In particular, when an in-cell touch sensor technology is applied to an organic light emitting diode display panel for emitting light by itself, the parasitic capacitance may be further increased due to the structural characteristics of the organic light emitting diode display panel.

Therefore, the present specification is directed to providing an in-cell touch display device in which an in-cell touch sensor technology can be implemented in an organic light emitting diode display panel.

The objects of one embodiment of the present specification are not limited to the above-described objects, and other objects that are not mentioned will be able to be clearly understood by those skilled in the art from the following description.

An in-cell touch display device according to one aspect of the present disclosure may include a substrate, a transistor formation layer formed on the substrate and including a semiconductor, a source electrode, a drain electrode, and a gate electrode, and a light emitting element layer formed on the transistor formation layer and including an anode electrode, an emission layer, and a cathode electrode, in which a plurality of touch electrodes forming a coupling capacitor with the cathode electrode of the light emitting element layer may be formed in the transistor formation layer.

An in-cell touch display device according to another aspect of the present disclosure may include a display panel including a plurality of sub-pixels having a light emitting element and a thin film transistor, and a plurality of touch electrodes formed in a transistor formation layer in which the thin film transistor is formed to form a coupling capacitor with a cathode electrode of the light emitting element, the cathode electrode being disposed above the plurality of touch electrodes, and a sensing circuit configured to sense a touch signal by primarily integrating a signal output from the touch electrode and secondarily integrating the integrated signal.

### BRIEF DESCRIPTION OF THE DRAWINGS

FIG. 1 shows an in-cell touch display device according to one embodiment of the present disclosure.

FIG. 2 shows a timing diagram of the in-cell touch display device according to one embodiment of the present disclosure.

FIGS. 3A and 3B show a sensing circuit and a touch driving state of a touch driving circuit according to a first embodiment of the present disclosure.

FIGS. 4A and 4B show a sensing circuit and a touch driving state of a touch driving circuit according to a second embodiment of the present disclosure.

FIGS. 5A and 5B show an equivalent circuit and the touch driving state of the touch driving circuit according to the second embodiment of the present disclosure.

FIGS. 6A and 6B show a parallel RLC circuit and voltage characteristics according to values of τ and ω_{d}.

FIGS. 7A and 7B show a parallel RLC circuit to which a modulation voltage is applied and voltage characteristics according to the application of the modulation voltage.

FIG. 8 shows a power modulation circuit to which the in-cell touch display device according to one embodiment of the present disclosure is applied.

FIG. 9 shows a cross-sectional view of a display panel in the in-cell touch display device according to one embodiment of the present disclosure.

FIG. 10 schematically shows a touch sensor structure of the in-cell touch display device according to one embodiment of the present disclosure.

FIG. 11 shows a cross-sectional view of a display panel in the in-cell touch display device according to one embodiment of the present disclosure.

FIG. 12 shows a sensing circuit in the in-cell touch display device according to one embodiment of the present disclosure.

FIG. 13 shows a driving state of the in-cell touch display device according to one embodiment of the present disclosure.

FIG. 14 shows a driving timing diagram in the in-cell touch display device according to one embodiment of the present disclosure.

FIG. 15 shows the display panel in the in-cell touch display device according to one embodiment of the present disclosure.

FIG. 16 shows an equivalent circuit diagram of a touch unit of FIG. 15 according to one embodiment of the present disclosure.

FIG. 17 shows an output value of a touch electrode according to a touch location of FIG. 15 according to one embodiment of the present disclosure.

### DETAILED DESCRIPTION

Advantages and features of the present specification and methods for achieving them will become clear with reference to embodiments described below in detail in conjunction with the accompanying drawings. However, the present specification is not limited to the embodiments disclosed below but can be implemented in various different forms, these embodiments are merely provided to make the disclosure of the present specification complete and fully inform those skilled in the art to which the present specification pertains of the scope of the present specification, and the present specification is only defined by the scope of the appended claims.

Since shapes, sizes, ratios, angles, numbers, and the like disclosed in the drawings for describing the embodiments of the present specification are illustrative, the present specification is not limited to the illustrated items. The same reference number indicates the same components throughout the specification. In addition, in describing the present specification, when it is determined that the detailed description of a related known technology may unnecessarily obscure the gist of the present specification, detailed description thereof will be omitted. When terms “comprises,” “has,” “includes,” and the like described in the present specification are used, other parts may be added unless “only” is used. When a component is expressed in the singular, it includes a case in which the component is provided as a plurality of components unless specifically stated otherwise.

In construing a component, the component is construed as including the margin of error even when there is no separate explicit description.

When the temporal relationship is described, for example, when the temporal relationship is described using the term “after,” “subsequently,” “then,” “before,” or the like, it may include a non-consecutive case unless the term “immediately” or “directly” is used.

In the description of the signal flow relationship, for example, in the case of “a signal is transmitted from node A to node B,” a case where the signal is transmitted from node A to node B via another node may be included unless “immediately” or “directly” is used.

Although terms such as first, second, and the like are used to describe various components, these components are not limited by these terms. The terms are only used to distinguish one component from another. Therefore, a first component described below may be a second component within the technical spirit of the present specification.

Features of various embodiments of the present specification can be coupled or combined partially or entirely, and various technological interworking and driving are possible, and the embodiments may be implemented independently of each other or implemented together in an associated relationship.

Hereinafter, an in-cell touch display device capable of improving touch sensitivity and the accuracy of touch recognition according to some embodiments will be described.

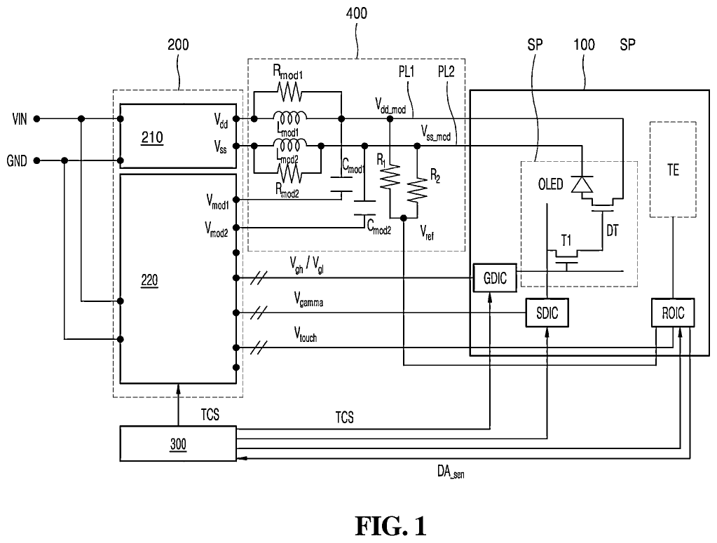

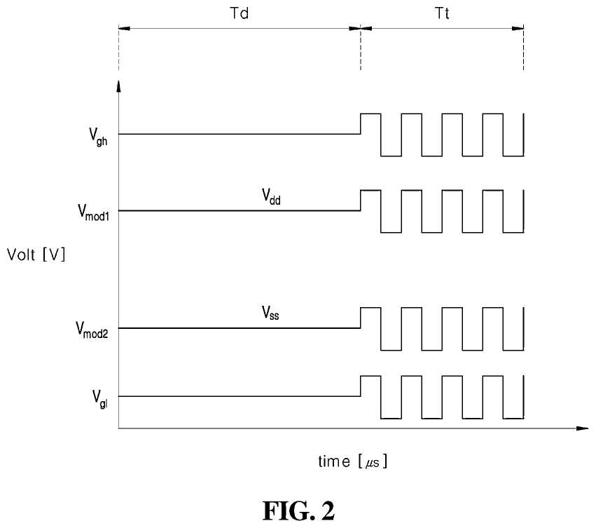

FIG. 1 shows an in-cell touch display device according to one embodiment of the present disclosure. FIG. 2 shows a timing diagram of the in-cell touch display device according to one embodiment of the present disclosure.

Referring to FIGS. 1 and 2, the in-cell touch display device may include a display panel 100, a power supply circuit 200, a power modulation circuit 400, a source driver SDIC, a gate driver GDIC, a touch driving circuit ROIC, a controller 300, etc.

The display panel 100 may include a plurality of sub-pixels SP and a plurality of touch electrodes TE and may be driven in a display time Td and a touch time Tt in a time-division manner. The plurality of touch electrodes TE may be embedded in a pixel array to detect a touch input.

During the display time Td, a data voltage corresponding to an image signal may be written on the pixel array of the display panel 100, and during the touch time Tt, the touch electrodes TE of the display panel 100 may be driven to detect the touch input.

The power supply circuit 200 may include the first power supply circuit 210 and the second power supply circuit 220.

The first power supply circuit 210 may generate a high potential power voltage V_{dd} and a low potential power voltage Vₛₛ based on input power VIN and ground power GND and supply the high potential power voltage V_{dd} and the low potential power voltage Vₛₛ to first RLC circuits Rmod1, Lmod1, and Cmod1 and second RLC circuits R_{mod2}, L_{mod2}, and C_{mod2} of the power modulation circuit 400, respectively.

The second power supply circuit 220 may generate a first modulation control voltage V_{mod1} and a second modulation control voltage V_{mod2} used to modulate the high potential power voltage V_{dd} and the low potential power voltage Vₛₛ based on the input power VIN and ground power GND and supply the first modulation control voltage V_{mod1} and the second modulation control voltage V_{mod2} to one ends of the first capacitor C_{mod1} of the first RLC circuit and one end of the second capacitor C_{mod2} of the second RLC circuit, respectively.

During the display time, the second power supply circuit 220 may supply the first modulation control voltage V_{mod1} at the level of the high potential power voltage V_{dd} and supply the second modulation control voltage V_{mod2} at the level of the low potential power voltage Vₛₛ.

In addition, during the touch time, the second power supply circuit 220 may supply the first modulation control voltage V_{mod1} at a level having a predetermined cycle and amplitude with respect to the level of the high potential power voltage V_{dd} and supply the second modulation control voltage V_{mod2} at a level having a predetermined cycle and amplitude with respect to the level of the low potential power voltage Vₛₛ.

In addition, during the display time, the second power supply circuit 220 may generate a high potential gate driving voltage V_{gh} and a low potential gate driving voltage V_{gl} based on the input power VIN and the ground power GND and supply the high potential gate driving voltage V_{gh} and the low potential gate driving voltage V_{gl} to the gate driver GDIC.

In addition, during the display time, the second power supply circuit 220 may supply a gamma voltage V_{gamma} to the source driver SDIC based on the input power VIN and the ground power GND.

In addition, during the touch time, the second power supply circuit 220 may modulate the high potential gate driving voltage V_{gh} into the level having the predetermined cycle and amplitude with respect to the high potential gate driving voltage V_{gh} and modulate the low potential gate driving voltage V_{gl} into the level having the predetermined cycle and amplitude with respect to the low potential gate driving voltage V_{gl}, and supply the modulated high potential and low potential gate driving voltages to the gate driver GDIC.

In addition, during the touch time, the second power supply circuit 220 may supply a touch driving voltage Vtouch having a predetermined cycle and amplitude to the touch driving circuit ROIC for sensing a change in capacitance of the touch electrode TE.

In addition, the second power supply circuit 220 may modulate the gamma voltage V_{gamma} into a level having a predetermined cycle and amplitude with respect to the gamma voltage V_{gamma} and supply the modulated gamma voltage to the source driver SDIC.

The power modulation circuit 400 may include the first RLC circuits R_{mod1}, L_{mod1}, and C_{mod1} in which the resistor, the inductor, and the capacitor are connected in parallel to the high potential power line PL1 to which the high potential power voltage V_{dd} is supplied in the display panel 100; and the second RLC circuits Rmod2, Lmod2, and Cmod2 in which the resistor, the inductor, and the capacitor are connected in parallel to the low potential power line PL2 to which the low potential power voltage Vss is supplied in the display panel 100.

During the touch time, the power modulation circuit 400 may modulate the high potential power voltage V_{dd} and the low potential power voltage Vₛₛ into a high potential modulation voltage V_{dd_mod} and a low potential modulation voltage V_{ss_mod} that have a resonance frequency of the resistor, the inductor, and the capacitor and supply the high potential modulation voltage V_{dd_mod} and the low potential modulation voltage V_{ss_mod} to a plurality of sub-pixels SP of the display panel 100.

During the touch time, the first RLC circuits R_{mod1}, L_{mod1}, and C_{mod1} may receive the first modulation control voltage V_{mod1} having a predetermined cycle and amplitude through one end of the first capacitor C_{mod1}. During the touch time, the second RLC circuits R_{mod2}, L_{mod2}, and C_{mod2} may receive the second modulation control voltage V_{mod2} having the predetermined cycle and amplitude through the one end of the second capacitor C_{mod2}.

Here, during the display time, the first modulation control voltage V_{mod1} may be applied at the level of the high potential power voltage V_{dd}, and the second modulation control voltage V_{mod2} may be applied at the level of the low potential power voltage Vₛₛ.

In addition, during the touch time, the first modulation control voltage V_{mod1} may be applied at the level having the predetermined cycle and amplitude with respect to the level of the high potential power voltage V_{dd}, and the second modulation control voltage V_{mod2} may be applied at the level having the predetermined cycle and amplitude with respect to the level of the low potential power voltage Vₛₛ.

The first RLC circuits R_{mod1}, L_{mod1}, and C_{mod1} may include the first resistor R_{mod1} having one end connected to an output terminal of the high potential power voltage V_{dd} and the other end connected to a driving transistor DT of the sub-pixel SP, the first inductor L_{mod1} having one end connected to the output terminal of the high potential power voltage V_{dd} and the other end connected to the driving transistor DT of the sub-pixel SP, and the first capacitor C_{mod1} having one end connected to the output terminal of the first modulation control voltage V_{mod1} and the other end connected to the driving transistor DT of the sub-pixel SP.

The second RLC circuits R_{mod2}, L_{mod2}, and C_{mod2} may include the second resistor R_{mod2} having one end connected to an output terminal of the lower potential power voltage Vₛₛ and the other end connected to a light emitting element OLED of the sub-pixel SP, the second inductor L_{mod2} having one end connected to the output terminal of the low potential power voltage Vₛₛ and the other end connected to the light emitting element OLED of the sub-pixel SP, and the second capacitor C_{mod2} having one end connected to the output terminal of the second modulation control voltage V_{mod2} and the other end connected to the light emitting element OLED of the sub-pixel SP.

The power modulation circuit 400 may further include a first distribution resistor R₁ having one end connected to the first power line PL1 and the other end connected to an output terminal of a reference voltage V_{ref}, and a second distribution resistor R₂ having one end connected to the second power line PL2 and the other end connected to the output terminal of the reference voltage V_{ref}.

A node between the first distribution resistor R₁ and the second distribution resistor R₂ is the output terminal of the reference voltage V_{ref}, and the output terminal of the reference voltage V_{ref} may be connected to an input terminal of the touch driving circuit ROIC for sensing a change in capacitance of the touch electrode TE.

Here, during the touch time, the reference voltage V_{ref} may be modulated into a level having the same cycle and amplitude as the high potential modulation voltage V_{dd_mod} and the low potential modulation voltage V_{ss_mod} that are modulated by the first RLC circuits R_{mod1}, L_{mod1}, and C_{mod1} and the second RLC circuits R_{mod2}, L_{mod2}, and C_{mod2}.

The source driver SDIC may modulate input image data into the corresponding data voltage using the gamma voltage V_{gamma} and supply the data voltage to a source electrode of a scan transistor T1 of the sub-pixel SP through a data line (or a data wire) of the display panel 100.

The gate driver GDIC may generate a scan signal using the high potential gate driving voltage V_{gh} and the low potential gate driving voltage V_{gl} and supply the scan signal to a gate electrode of the scan transistor T1 of the sub-pixel SP through a gate line of the display panel 100.

The touch driving circuit ROIC may generate a touch drive signal having the same cycle and amplitude as the high potential modulation voltage V_{dd_mod} and the low potential modulation voltage V_{ss_mod} using the touch driving voltage Vtouch and supply the touch drive signal to a plurality of touch electrodes TE of the display panel 100.

In addition, the touch driving circuit ROIC may detect a change in capacitance of the touch electrode TE, modulate a detection voltage into detection data DA_sen, which is a digital signal, and provide the detection data DA_sen to the controller 300.

The controller 300 may control operation timings of the second power supply circuit 220, the gate driver GDIC, the source driver SDIC, and the touch driving circuit ROIC using a touch control signal TCS.

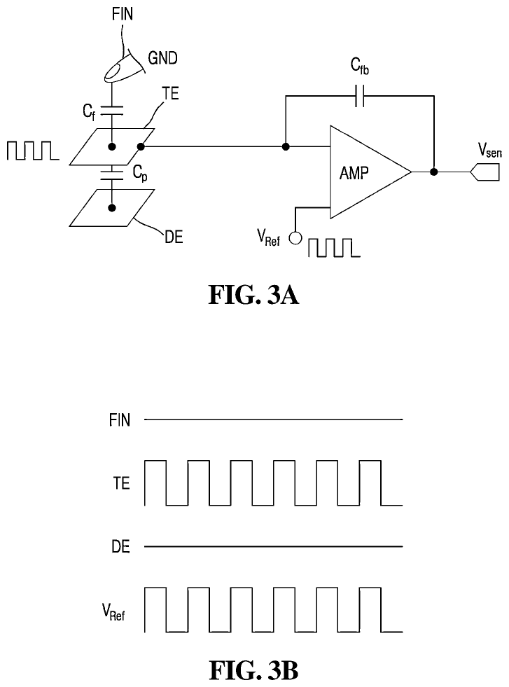

FIGS. 3A and 3B show a sensing circuit and a touch driving state of a touch driving circuit according to a first embodiment of the present disclosure.

In the case of an in-cell touch technology in which the touch electrode TE is designed directly on a backplane of the thin film transistor of the organic light emitting diode display panel, a distance between the touch electrode TE and a display electrode DE is relatively decreased, thereby greatly increasing the parasitic capacitance between the two electrodes.

In the case of add-on, the distance between the touch electrode TE and the display electrode DE is proportional to the thickness of the substrate of the touch electrode TE and has a value of about 500 μm. On the other hand, in the case of in-cell touch, a distance between the touch electrode and the display electrode is very small at a level of about ˜μm, thereby increasing a parasitic capacitance of a parasitic capacitor Cₚ and degrading touch performance.

Here, the display electrode DE may be defined as an electrode or line for display driving in the display panel 100.

As shown in FIGS. 3A and 3B, when charges of the touch electrode TE are sensed by modulating the reference voltage V_{ref}, the amount of charges accumulated in a feedback capacitor C_{fb} may become (Cₚ+C_{f})*V_{ref}.

In this case, since the amount of charges that may be accumulated in the feedback capacitor C_{fb} is limited, as the parasitic capacitance of the parasitic capacitor Cₚ increases, the amount of charges that may be accumulated in the feedback capacitor C_{fb} becomes relatively small, thereby degrading touch performance.

As described above, when the in-cell touch is designed in the organic light emitting diode display panel, the parasitic capacitance of the touch electrode TE may become very large, thereby degrading touch performance, and consumed power may increase because a very great parasitic capacitance should be filled. In addition, the driving voltage of the touch electrode may distort the display signal through the coupling capacitor with an adjacent display electrode, thereby degrading image quality. In addition, when the display and touch are driven simultaneously, the display electrode DE and the touch electrode TE are mutually influenced by the parasitic capacitance, thereby degrading image quality and touch performance at the same time.

The present disclosure provides an in-cell touch display device capable of improve the touch sensitivity and accuracy of touch recognition even when an in-cell touch sensor technology is applied to the organic light emitting diode display panel.

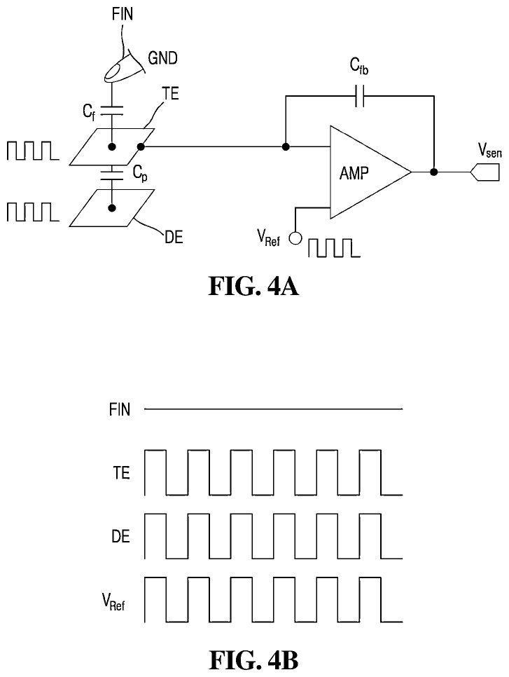

FIGS. 4A and 4B show a sensing circuit and a touch driving state of a touch driving circuit according to a second embodiment of the present disclosure.

Referring to FIGS. 4A and 4B, when a driving voltage having the same cycle and amplitude is applied to the touch electrode TE and the display electrode DE, there is no voltage difference between the electrodes of the parasitic capacitor Cₚ, and thus there is no change in the amount of charges charged in the parasitic capacitor Cₚ.

On the other hand, in the case of a finger capacitor C_{f} between the finger FIN and the touch electrode TE, since one side is in the ground GND state, and the driving voltage is applied to the other side, the amount of charges charged in the finger capacitor C_{f} is proportional to the driving voltage.

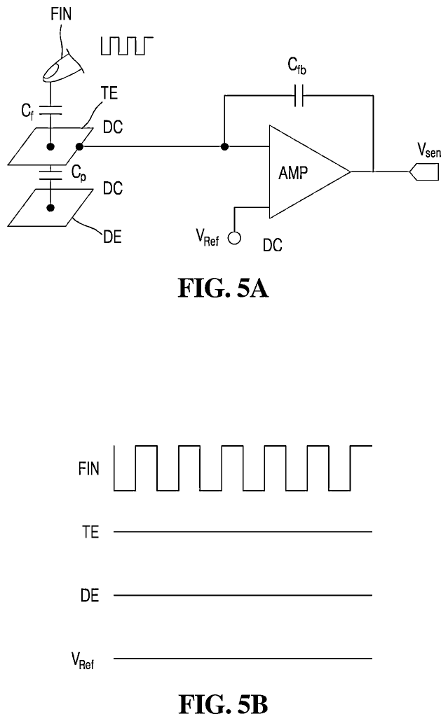

FIGS. 5A and 5B show an equivalent circuit and the touch driving state of the touch driving circuit according to the second embodiment of the present disclosure.

Referring to FIGS. 5A and 5B, since the voltage is relative, it may be considered equivalent to the case where the driving voltage in a form of pulse is applied to only a ground electrode of the finger FIN in a state in which the touch electrode TE, the display electrode DE, and an input terminal of the reference voltage V_{ref} are DC.

The amount of charges sensed at this time may be represented by the product of the driving voltage generated from the finger FIN and the capacitance of the finger capacitor C_{f}.

Therefore, when the touch electrode TE, the display electrode DE, and the input terminal of the reference voltage V_{ref} are driven by a driving signal having the same cycle and amplitude as described above, only the amount of charges stored in the finger capacitor C_{f} may be read regardless of the parasitic capacitance of the parasitic capacitor Cₚ, thereby improving touch performance.

Referring back to FIGS. 1 and 2, the in-cell touch display device according to one embodiment of the present disclosure may generate the modulation voltage having the same cycle and amplitude in the display electrode and the touch electrode.

The organic light emitting diode display panel may have the high potential power voltage V_{dd} and the low potential power voltage Vₛₛ that supply a current, a gate voltage (or a scan pulse), a data voltage, etc.

The power supply circuit 200 may generate the high potential power voltage V_{dd} and the low potential power voltage Vₛₛ based on the input power VIN and the ground power GND and provide the high potential power voltage V_{dd} and the low potential power voltage Vₛₛ to the first RLC circuits R_{mod1}, L_{mod1}, and C_{mod1} and the second RLC circuits R_{mod2}, L_{mod2}, and C_{mod2} respectively.

In addition, the power supply circuit 200 may generate the first modulation control voltage V_{mod1} and the second modulation control voltage V_{mod2} used to modulate the high potential power voltage V_{dd} and the low potential power voltage Vₛₛ based on the input power VIN and ground power GND and provide the first modulation control voltage V_{mod1} and the second modulation control voltage V_{mod2} to one ends of the first capacitor C_{mod1} of the first RLC circuit and one end of the second capacitor C_{mod2} of the second RLC circuit, respectively.

In addition, during the display period, the power supply circuit 200 may provide the high potential gate driving voltage V_{gh} and the low potential gate driving voltage V_{gl} to the gate driver GDIC and provide the gamma voltage V_{gamma} to the source driver SDIC.

In addition, during the touch time, the power supply circuit 200 may modulate the high potential gate driving voltage V_{gh} and the low potential gate driving voltage V_{gl} into levels having a predetermined cycle and amplitude and provide the modulated high potential gate driving voltage V_{gh} and low potential gate driving voltage V_{gl} to the gate driver GDIC.

In addition, during the touch time, the power supply circuit 200 may provide the touch driving voltage V_{touch} having the predetermined cycle and amplitude to the touch driving circuit ROIC. In addition, the power supply circuit 200 may modulate the gamma voltage V_{gamma} into the level having the predetermined cycle and amplitude and provide the modulated gamma voltage to the source driver SDIC.

The power modulation circuit 400 may modulate the high potential power voltage V_{dd} and the low potential power voltage Vₛₛ output from the power supply circuit 200 into the high potential modulation voltage V_{dd_mod} and the low potential power voltage V_{ss_mod} using the first RLC circuits R_{mod1}, L_{mod1}, and C_{mod1} and the second RLC circuits R_{mod2}, L_{mod2}, and C_{mod2}.

During the touch time, the power modulation circuit 400 may modulate the high potential power voltage V_{dd} and the low potential power voltage Vₛₛ into the high potential modulation voltage V_{dd_mod} and the low potential power voltage V_{dd_mod} that have the same cycle and amplitude as the touch driving voltage V_{touch} and provide the modulated high potential modulation voltage V_{dd_mod} and low potential power voltage V_{dd_mod} to a plurality of sub-pixels.

In addition, the power modulation circuit 400 may provide the modulated display voltage having the same cycle and amplitude as the touch driving voltage V_{touch} to the gate driver GDIC and the source driver SDIC based on the high potential modulation voltage V_{dd_mod} and the low potential modulation voltage V_{ss_mod}.

In addition, the power modulation circuit 400 may provide the modulated reference voltage having the same cycle and amplitude as the touch driving voltage V_{touch} to the touch driving circuit ROIC based on the high potential modulation voltage V_{dd_mod} and the low potential modulation voltage Vₛₛ mod.

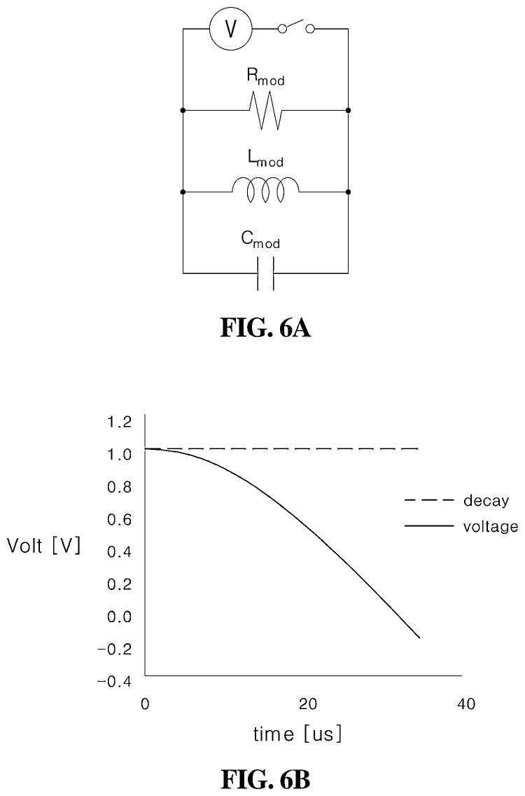

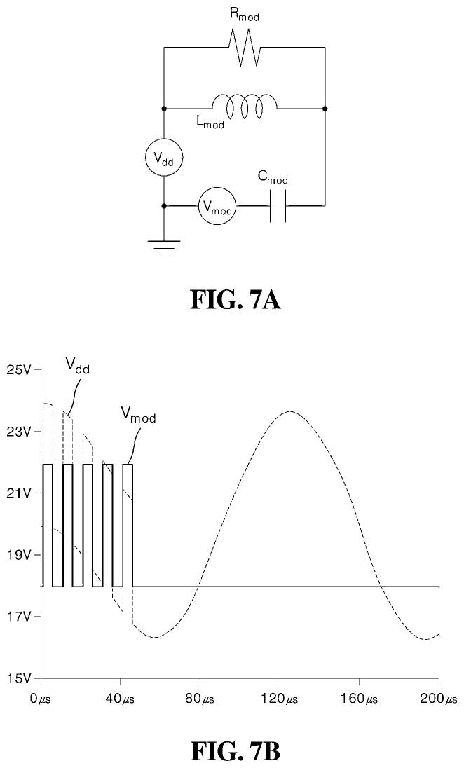

FIGS. 6A and 6B show a parallel RLC circuit and voltage characteristics according to values of τ and ω_{d}. FIGS. 7A and 7B show a parallel RLC circuit to which a modulation control voltage is applied and voltage characteristics according to the application of the modulation control voltage.

Referring to FIGS. 6A and 6B, when a switch of the parallel RLC circuit is turned on, a voltage applied to the circuit is shown in Equation 1.

$$V = {V}_{0} exp ( - t / τ ) sin ( {ω}_{d} t ) \qquad [ Equation 1 ]$$

In this case, voltage characteristics according to values of τ=1 and ω_{d}=50 kHz are shown in FIG. 6B.

Under the above condition, when five modulation control voltage pulses are applied in the start section as shown in FIG. 7A and FIG. 7B, waveforms shown in FIG. 7B can be obtained. When τ is great and ω_{d} is small, it can be seen that the applied modulation control voltage V_{mod} is output by being loaded on the high potential power voltage V_{dd}.

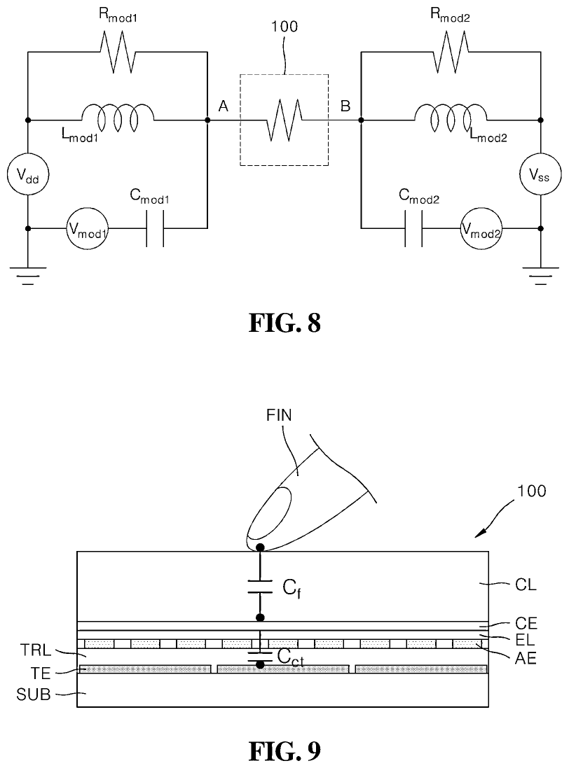

FIG. 8 shows a power modulation circuit to which the in-cell touch display device according to one embodiment of the present disclosure is applied.

Referring to FIG. 8, the high potential power voltage V_{dd} and the low potential power voltage Vₛₛ are designed with the resistors R_{mod1} and R_{mod2}, the inductors L_{mod1} and L_{mod2}, and the capacitors C_{mod1} and C_{mod2} that have the same values, and when the modulation control voltages V_{mod1} and V_{mod2} having the same value are applied, a voltage difference between node A and node B may always be kept constant.

That is, the high potential power voltage V_{dd} and the low potential power voltage Vₛₛ are applied to a load terminal of the display panel 100, and the flowing current may be kept constant regardless of the modulation control voltages V_{mod1} and V_{mod2}.

In addition, when the modulation control voltages V_{mod1} and V_{mod2} are generated and applied based on the high potential power voltage V_{dd} and the low potential power voltage Vₛₛ, respectively, harmonic components of the high potential modulation voltage V_{dd_mod} and the low potential modulation voltage V_{ss_mod} may be greatly reduced.

According to the embodiments of the present disclosure, when the in-cell touch sensor technology is applied to the display panel, it is possible to prevent the generation of the parasitic capacitance between the touch electrode and the display electrode, thereby improving the touch sensitivity and accuracy of touch recognition.

In addition, it is possible to reduce the thickness of the display panel, implement the curved surface, and improve the degradation of the image quality due to crosstalk with the touch voltage.

In addition, it is possible to easily generate the uplink signal by increasing the touch sensitivity, thereby enabling the active pen touch.

In addition, since the frequency and the damping constant may be adjusted through the resistance value, the inductor can be implemented even when the inductor is not large.

The in-cell touch display device according to one aspect of the present disclosure allows the in-cell touch sensor technology to be implemented in the organic light emitting diode display panel.

FIG. 9 shows a cross-sectional view of a display panel in the in-cell touch display device according to one embodiment of the present disclosure.

Referring to FIG. 9, the display panel 100 of the in-cell touch display device according to one aspect of the present disclosure may include a substrate SUB, a transistor formation layer TRL, light emitting element layers AE, EL, and CE, and a cover layer CL.

The transistor formation layer TRL may be formed on the substrate SUB.

The transistor formation layer TRL may include a plurality of touch electrodes TE forming a coupling capacitor C_{ct} with the cathode electrode CE of the light emitting element layer. The plurality of touch electrodes TE may be formed as a transparent electrode and formed on the substrate SUB at a predetermined interval. Alternatively, the touch electrode TE may be formed on the same layer as the metal of the transistor formation layer TRL by the same process with the same material as the metal of the transistor formation layer TRL.

The light emitting element layers AE, EL, and CE may be formed on the transistor formation layer TRL.

The light emitting element layers AE, EL, CE may include the anode electrode AE, the emission layer EL, and the cathode electrode CE. The anode electrode AE may be formed on the transistor formation layer TRL at a predetermined interval. The emission layer EL may be formed between the anode electrode AE and the cathode electrode CE. The emission layer EL may be made of an organic material. The cathode electrode CE may be formed on the emission layer EL.

The cover layer CL may be formed on the light emitting element layers AE, EL, and CE. When the touch object FIN touches the cover layer CL, the capacitor C_{f} may be formed between the touch object FIN and the cathode electrode. In the present specification, the capacitor C_{f} between the touch target FIN and the cathode electrode is referred to as the object capacitor C_{f} or the finger capacitor C_{f}. The capacitor C_{ct} may also be formed between the cathode electrode CE and the touch electrode TE. In the present specification, the capacitor C_{ct} formed between the cathode electrode CE and the touch electrode TE is referred to as the coupling capacitor Cc. When the finger capacitor C_{f} and the coupling capacitor C_{ct} are formed in the display panel 100, touch detection may be performed even when a touch location is any location of the display panel.

The anode electrode AE between the touch electrode TE and the cathode electrode CE may be considered a floating electrode because the resistance of the driving thin film transistor becomes very large upon expressing a low grayscale, and thus the capacitance value of the coupling capacitor C_{ct} can be maintained.

In addition, the influence of the anode electrode AE between the touch electrode TE and the cathode electrode CE on the coupling capacitor C_{ct} may be very small because a capacitor between the cathode electrode CE and the anode electrode AE, and a gate-source capacitor of the driving thin film transistor form a series capacitor due to a small resistance of the driving thin film transistor upon expressing a high grayscale.

Therefore, when the object touches the display panel 100, the touch may be detected by sensing a change in capacitance of the finger capacitor C_{f} and the coupling capacitor C_{ct} that are formed in the display panel 100.

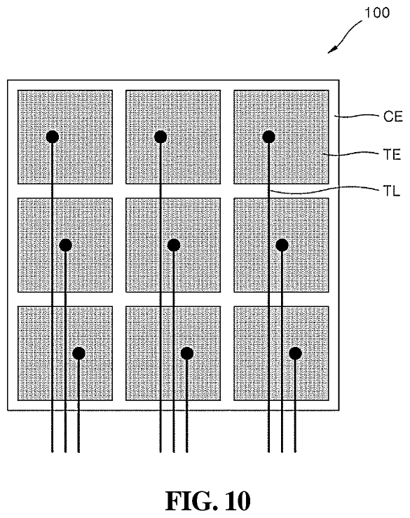

FIG. 10 schematically shows a touch sensor structure of the in-cell touch display device according to one embodiment of the present disclosure.

Referring to FIG. 10, the touch sensor of the display panel 100 may include the touch electrode TE and a touch line TL.

The cathode electrode CE may be formed on an entire surface of a display area of the display panel 100.

A plurality of touch electrodes TE may be disposed in a form of grid in the display area.

The touch line TL may be electrically connected to each touch electrode TE. A signal of each touch electrode TE may be transmitted to an external sensing circuit through the touch line TL.

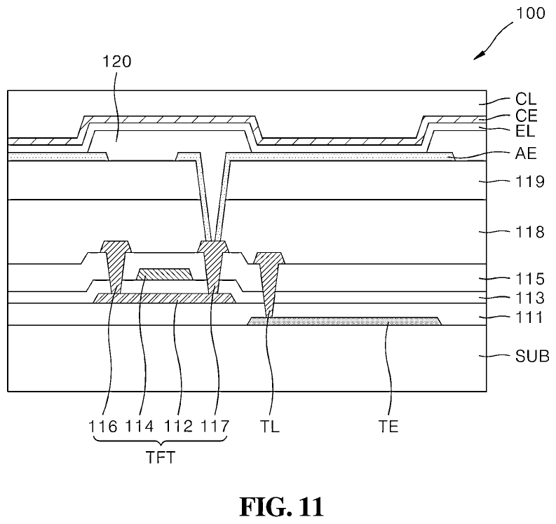

FIG. 11 shows a cross-sectional view of a display panel in the in-cell touch display device according to one embodiment of the present disclosure.

Referring to FIG. 11, the display panel 100 may include the substrate SUB, the transistor formation layer TRL in which the thin film transistor TFT and the touch electrode TE are formed, the light emitting element layers AE, EL, and CE, and the cover layer CL.

The touch electrode TE may be formed on the substrate SUB at a predetermined interval.

A buffer layer 111 may be formed on the substrate SUB and the touch electrode TE. The buffer layer 111 may be made of an insulating material.

The semiconductor 112 of the thin film transistor TFT may be formed on the buffer layer 111.

The gate insulating layer 113 may be formed on the semiconductor 112 and the buffer layer 111.

The gate electrode 114 may be formed at the location overlapping the semiconductor 112 on the gate insulating layer 113.

An interlayer insulating layer 115 may be formed on the gate electrode 114 and the gate insulating layer 113.

The source electrode 116 and the drain electrode 117 may be formed on the interlayer insulating layer 115. The source electrode 116 and the drain electrode 117 may be electrically connected to the semiconductor 112 through contact holes.

In addition, the touch line TL may be formed on the interlayer insulating layer 115. The touch line TL may be electrically connected to the touch electrode TE through a contact hole.

For example, the touch line TL may be formed on the same layer as the source electrode 116 and the drain electrode 117. Alternatively, the touch line TL may be formed in a direction parallel to the data line (not shown in FIG. 11) by being formed on a different layer from the source electrode 116 and the drain electrode 117. The data voltage may be applied to the data line, and the gate line may be electrically connected to the gate electrode 114 of the driving transistor through the scan transistor (not shown in FIG. 11).

A first planarization layer 118 may be formed on the source electrode 116, the drain electrode 117, the touch line TL, and the interlayer insulating layer 115.

A second planarization layer 119 may be formed on the first planarization layer 118.

Meanwhile, a stacking location of the touch electrode TE is illustrative, and the touch electrode TE is not limited to being disposed between the substrate SUB and the buffer layer 111. For example, the touch electrode TE may be disposed on same layer as the gate electrode 114 or on same layer as the source electrode 116 and the drain electrode 117. Alternatively, the touch electrode TE may be disposed between the first planarization layer 118 and the second planarization layer 119.

The anode electrode AE of the organic light emitting diode may be formed on the second planarization layer 119. The anode electrode AE may be electrically connected to the drain electrode 117 of the thin film transistor TFT through the pixel contact hole.

In addition, the bank layer 120 may be formed on a portion of the second planarization layer 119 and a portion of the anode electrode AE. The bank layer 120 may be made of an opaque material to prevent light interference between pixels adjacent to each other.

The emission layer EL may be formed on the anode electrode AE. The emission layer EL may be made of an organic light emitting material.

The cathode electrode CE may be formed on the emission layer EL.

The cover layer CL may be formed on the cathode electrode CE. The cover layer CL may be made of a transparent material.

In the in-cell touch display device according to the present disclosure, during the touch time, the touch driving signal having the predetermined cycle and amplitude may be applied to the touch electrode TE, and the low potential modulation voltage V_{ss_mod} (see FIG. 1) having the same cycle and amplitude as the touch driving signal may be applied to the cathode electrode CE.

The touch electrode TE may form a coupling capacitor C_{ct} with the cathode electrode CE. The coupling capacitor C_{ct} may be formed between the touch electrode TE and the cathode electrode CE to enable touch detection regardless of a touch location.

The anode electrode AE between the touch electrode TE and the cathode electrode CE may be considered a floating electrode because the resistance of the driving thin film transistor becomes very large upon expressing a low grayscale, and thus the capacitance value of the coupling capacitor Ca can be maintained.

In addition, the influence of the anode electrode AE between the touch electrode TE and the cathode electrode CE on the coupling capacitor C_{ct} may be very small because a capacitor between the cathode electrode CE and the anode electrode AE, and a gate-source capacitor of the driving thin film transistor form a series capacitor due to a small resistance of the driving thin film transistor upon expressing a high grayscale. Therefore, the touch detection may be performed.

The in-cell touch display device may be driven in the display time and the touch time in a time-division manner, and the touch driving signal during the touch time may have a predetermined cycle and amplitude.

For example, during the touch time, the high potential power voltage V_{dd} and the low potential power voltage Vₛₛ may be modulated into the high potential modulation voltage V_{dd_mod} and the low potential modulation voltage V_{ss_mod} that have the same cycle and amplitude as the touch driving voltage and supplied to the plurality of sub-pixels.

In addition, display voltages (e.g., a gamma voltage, a gate high potential voltage, and a gate low potential voltage) may be modulated into a voltage having the same cycle and amplitude as the touch driving voltage based on the high potential modulation voltage V_{dd_mod} and the low potential modulation voltage V_{ss_mod}.

In addition, the reference voltage V_{ref} may be modulated into a voltage having the same cycle and amplitude as the touch driving voltage based on the high potential modulation voltage V_{dd_mod} and the low potential modulation voltage V_{ss_mod}.

As described above, referring to FIGS. 9 to 11, the touch electrode TE and the thin film transistor TFT may be formed on the substrate SUB, the light emitting element layers AE, EL, and CE may be deposited on the touch electrode TE and the thin film transistor TFT, and upon touching of the object FIN, the touch signal may be transmitted to the touch line TL through the object capacitor C_{f} and the coupling capacitor C_{ct}.

In this case, as the touch signal passes through the object capacitor C_{f} and the coupling capacitor C_{ct} twice, an original signal is differentiated twice. In the in-cell touch display device according to the present disclosure, the sensing circuit for detecting the touch signal has two integrator embedded therein and detect the touch signal by integrating the touch signal twice. Here, the sensing circuit is a read-out circuit and may be included in the touch driving circuit ROIC (see FIG. 1).

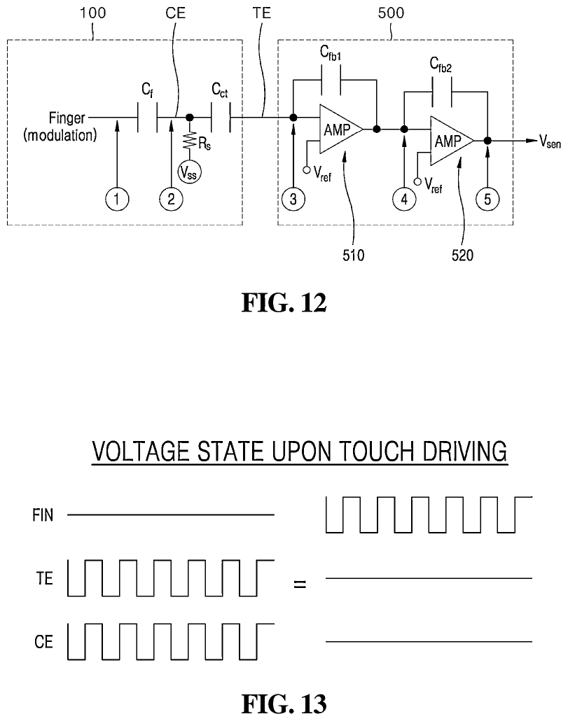

FIG. 12 shows a sensing circuit in the in-cell touch display device according to one embodiment of the present disclosure.

Referring to FIG. 12, a sensing circuit 500 senses the touch signal by primarily integrating a signal output from the touch electrode TE and secondarily integrating the integrated signal.

The sensing circuit 500 may include a first integrator 510 for primarily integrating the signal output from the touch electrode TE and a second integrator 520 for secondarily integrating the signal integrated by the first integrator 510.

The first integrator 510 may include a first operational amplifier AMP having a first input terminal for receiving the output signal of the touch electrode TE and a second input terminal to which the reference voltage Vref is applied, and a first feedback capacitor C_{fb1} connected between the first input terminal and an output terminal of the first operational amplifier AMP.

The second integrator 520 may include a second operational amplifier AMP having a third input terminal electrically connected to the output terminal of the first operational amplifier AMP and a fourth input terminal to which the reference voltage V_{ref} is applied, and a second feedback capacitor C_{fb2} connected between a third input terminal and an output terminal of the second operational amplifier AMP.

During the touch time, the touch drive signal applied to the touch electrode TE has a predetermined cycle and amplitude. The touch drive signal is differentiated twice through the object capacitor C_{f} and the coupling capacitor C_{ct}. The sensing circuit 500 may restore the touch drive signal by integrating the signal output from the touch electrode TE twice through the first integrator 510 and the second integrator 520 in order to restore the touch drive signal.

FIG. 13 shows a driving state of the in-cell touch display device according to one embodiment of the present disclosure.

Referring to FIG. 13, during the touch time, the touch drive signal having the predetermined cycle and amplitude may be applied to the touch electrode TE. In addition, the low potential modulation voltage V_{ss_mod} having the same cycle and amplitude as the touch drive signal may be applied to the cathode electrode CE. In addition, the reference voltage V_{ref} having the same cycle and amplitude as the touch drive signal may be applied to input terminals of reference voltages of the first integrator 510 and the second integrator 520.

In addition, FIG. 13 shows a voltage state of the equivalent circuit upon touch, and a sensing method in a case where it is assumed that upon touch, a signal is modulated by a potential of a touching finger is as follows.

First, the modulation signal transmitted by the finger is transformed into a primary differential signal through the object capacitor C_{f}. That is, the modulation signal is momentarily input and then output through a resistor Rₛ. The primary differential signal is transmitted to the first integrator 510 through the coupling capacitor C_{ct} and at this time, the signal is secondarily differentiated and input to the first integrator 510. The signal is integrated through the first integrator 510 and transformed into a form similar to the signal output through the object capacitor C_{f}. The signal is re-restored in the same form as the original modulation signal through the second integrator 520. Therefore, a final output value of the sensing circuit 500 is proportional to the magnitude of the touch input signal.

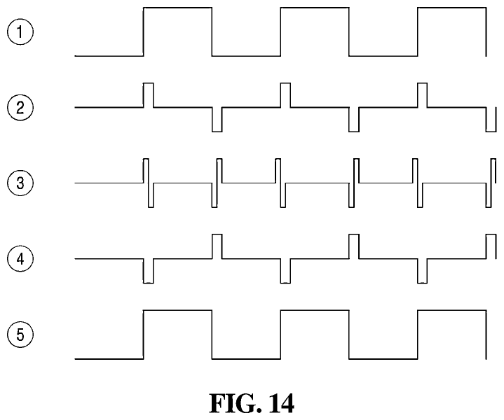

FIG. 14 shows a driving timing diagram in the in-cell touch display device according to one embodiment of the present disclosure.

Referring to FIG. 14, waveform \textcircled{1} shows a case where it is assumed that the potential of the finger applied to the object capacitor C_{f} is modulated when the touch drive signal having the predetermined cycle and amplitude is applied to the touch electrode TE, and the low potential modulation voltage V_{ss_mod} having the same cycle and amplitude as the touch drive signal is applied to the cathode electrode CE during the touch time.

Waveform \textcircled{2} shows a signal primarily differentiated through the object capacitor C_{f}, and waveform \textcircled{3} shows a signal secondarily differentiated through the coupling capacitor C_{ct}. Waveform \textcircled{4} shows a signal primarily integrated through the first integrator 510. Here, the primary integration signal is the same as a reversed signal of the primary differential signal. Waveform \textcircled{5} shows a signal secondarily integrated through the second integrator 520. Here, the second integration signal is the same as a signal restoring the signal of Waveform \textcircled{1}.

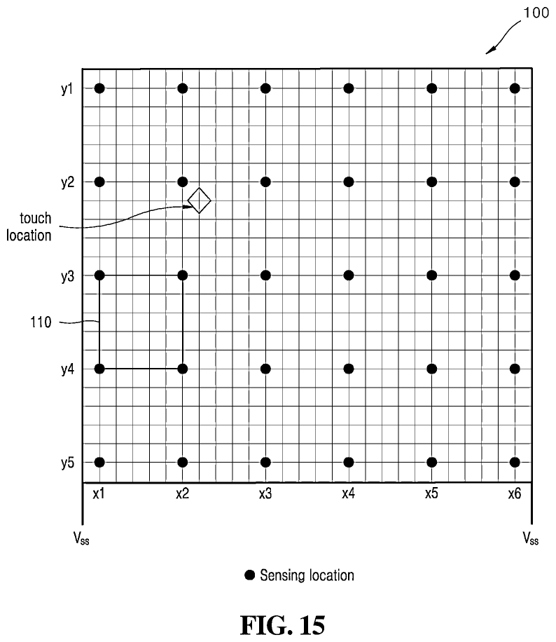

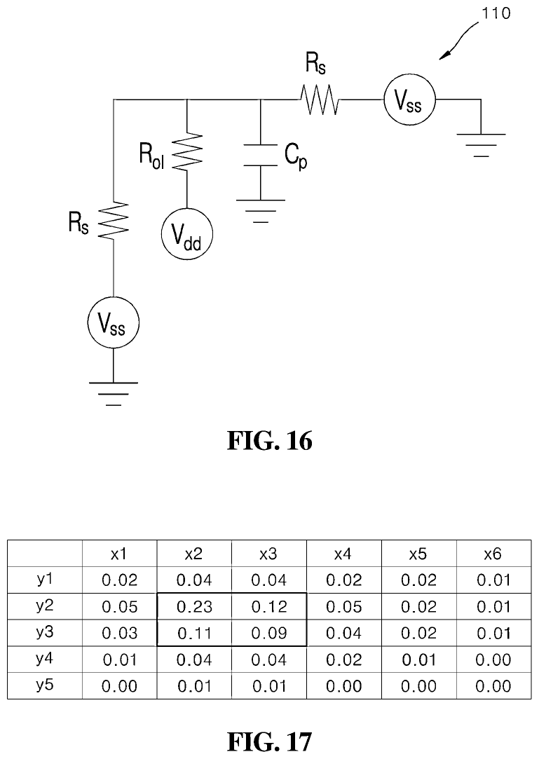

FIG. 15 shows the display panel in the in-cell touch display device according to one embodiment of the present disclosure. FIG. 16 shows an equivalent circuit diagram of a touch unit of FIG. 15 according to one embodiment of the present disclosure. FIG. 17 shows an output value of a touch electrode according to a touch location of FIG. 15 according to one embodiment of the present disclosure.

Simulation was performed through the display panel 100 configured as shown in FIG. 15 to check operational characteristics. First, a pixel unit had a resistor Rₒₗ disposed between the sheet resistor Rₛ and the parasitic capacitor Cₚ and between the sheet resistor Rₛ to which the low potential power voltage Vₛₛ is supplied and the high potential power voltage V_{dd}. Here, the resistor Rₒₗ serves as a serial resistor of the driving thin film transistor and the light emitting element.

The touch unit 110 was composed of a 5×5 pixel unit, and the touch panel 100 was composed of a 4×5 touch unit 110. The low potential power voltage Vₛₛ was supplied through a low potential power voltage line outside the touch panel 100. Magnitudes of the resistor Rₒₗ and the parasitic capacitor Cₚ were set to be equivalent to values of 20 touch units 110 in the display panel.

For example, the results obtained for one pulse under the conditions that the sheet resistance was 87 Ω/sh, the touch line resistance was 500 $2, the object capacitor C_{f} was 1 pf, and the modulation control voltage Vmod was 10 V are shown in FIG. 17. Touch locations may be obtained by outputting the touch drive signal applied by the pulse of the modulation control voltage from three and four areas of the touch electrode TE without spreading to the sheet resistor of the panel.

As described above, according to the embodiments of the present disclosure, since the touch electrode is formed in the backplane process of the thin film transistor, it is possible to implement the touch function in the organic light emitting diode display panel in the minimum process.

In addition, with respect to the problem that the touch signal is differentiated twice by the finger capacitor formed between the touch object and the cathode electrode by arranging the touch electrode in the transistor formation layer and the coupling capacitor formed between the cathode electrode and the touch electrode, the touch signal can be detected without errors by embedding two integrators in the sensing circuit.

In addition, it is possible to reduce the thickness of the display panel compared to the add-on touch and reduce the size of the bezel.

In addition, since the touch electrode is not present on the organic light emitting diode, it is possible to increase transmittance compared to the conventional touch technology.

In addition, since the touch electrode is formed by using the transparent electrode in the backplane of the thin film transistor, it is possible to enable the top and bottom emission of the organic light emitting diode.

In addition, since the touch electrode is located in the backplane of the thin film transistor, it is possible to enable double-sided touch.

In addition, it is possible to implement process optimization by reducing the touch cost and the production energy.

In addition, since the large parasitic capacitance between the touch electrode and the display electrode does not need to be filled, it is possible to reduce the consumed power, thereby implementing low power.

An in-cell touch display device according to one aspect of the present disclosure may include a substrate, a transistor formation layer formed on the substrate and including a semiconductor, a source electrode, a drain electrode, and a gate electrode, and a light emitting element layer formed on the transistor formation layer and including an anode electrode, an emission layer, and a cathode electrode, in which a plurality of touch electrodes forming a coupling capacitor with the cathode electrode of the light emitting element layer may be formed in the transistor formation layer.

According to one aspect of the present disclosure, a cover layer may be further formed on the light emitting element layer, and when a touch object touches the cover layer, an object capacitor may be formed between the touch object and the cathode electrode.

According to one aspect of the present disclosure, the in-cell touch display device may further include a sensing circuit configured to sense changes in capacitances of the object capacitor and the coupling capacitor through the touch electrode when the touch object touches the cover layer.

According to one aspect of the present disclosure, the touch electrode may be formed on the substrate in the transistor formation layer.

According to one aspect of the present disclosure, the touch electrode may be disposed on same layer as the gate electrode or on same layer as the source electrode and the drain electrode.

According to one aspect of the present disclosure, the in-cell touch display device may further include a touch line formed in the transistor formation layer and electrically connected to the touch electrode.

According to one aspect of the present disclosure, the touch line may be formed on the same layer as the source electrode and the drain electrode of the transistor formation layer.

According to one aspect of the present disclosure, the touch line may be formed in a direction parallel to a data line by being formed on a differing layer from the source electrode and the drain electrode of the transistor formation layer.

According to one aspect of the present disclosure, during a touch time, a touch drive signal having a predetermined cycle and amplitude may be applied to the touch electrode, and a low potential modulation voltage having the same cycle and amplitude as the touch drive signal may be applied to the cathode electrode.

According to one aspect of the present disclosure, the touch electrode may be formed as a transparent electrode.

An in-cell touch display device according to another aspect of the present disclosure may include a display panel including a plurality of sub-pixels having a light emitting element and a thin film transistor, and a plurality of touch electrodes formed in a transistor formation layer in which the thin film transistor is formed to form a coupling capacitor with a cathode electrode of the light emitting element, the cathode electrode being disposed above the plurality of touch electrodes, and a sensing circuit configured to sense a touch signal by primarily integrating a signal output from the touch electrode and secondarily integrating the integrated signal.

According to another aspect of the present disclosure, the sensing circuit may include a first integrator configured to primarily integrate a signal output from the touch electrode, and a second integrator configured to secondarily integrate the signal integrated by the first integrator.

According to another aspect of the present disclosure, the first integrator may include a first operational amplifier having a first input terminal configured to receive an output signal of the touch electrode and a second input terminal to which a reference voltage is applied, and a first feedback capacitor connected between the first input terminal and an outer terminal of the first operational amplifier.

According to another aspect of the present disclosure, the second integrator may include a second operational amplifier having a third input terminal electrically connected to the output terminal of the first operational amplifier and a fourth input terminal to which the reference voltage is applied, and a second feedback capacitor connected between the third input terminal and an outer terminal of the second operational amplifier.

According to another aspect of the present disclosure, during a touch time, a touch drive signal having a predetermined cycle and amplitude may be applied to the touch electrode, a low potential modulation voltage having the same cycle and amplitude as the touch drive signal may be applied to the cathode electrode, and the reference voltage having the same cycle and amplitude as the touch drive signal may be applied to the second input terminal of the first operational amplifier and the fourth input terminal of the second operational amplifier.

According to another aspect of the present disclosure, the display panel may include a substrate, a transistor formation layer formed on the substrate and including a semiconductor, a source electrode, a drain electrode, and a gate electrode, a light emitting element layer formed on the transistor formation layer and including an anode electrode, an emission layer, and a cathode electrode, and a cover layer formed on the light emitting element layer and having an object capacitor formed between a touch object and the cathode electrode when the touch object touches the cover layer, and the plurality of touch electrodes may be formed in the transistor formation layer and may form a coupling capacitor with the cathode electrode of the light emitting element layer.

According to another aspect of the present disclosure, a cover layer may be further formed on the light emitting element layer, and when the touch object touches the cover layer, an object capacitor may be formed between the touch object and the cathode electrode.

According to another aspect of the present disclosure, the sensing circuit may sense changes in capacitances of the object capacitor and the coupling capacitor through two integrators when the touch object touches the cover layer.

According to the embodiments of the present disclosure, since the touch electrode is formed in the backplane process of the thin film transistor, it is possible to implement the touch function in the organic light emitting diode display panel in the minimum process.

In addition, with respect to the problem that the touch signal is differentiated twice by the finger capacitor formed between the touch object and the cathode electrode by arranging the touch electrode in the transistor formation layer and the coupling capacitor formed between the cathode electrode and the touch electrode, the touch signal can be detected without errors by embedding two integrators in the sensing circuit.

In addition, it is possible to reduce the thickness of the display panel compared to the add-on touch and reduce the size of the bezel.

In addition, since the touch electrode is not present on the organic light emitting diode, it is possible to increase transmittance compared to the conventional touch technology.

In addition, since the touch electrode is formed by using the transparent electrode in the backplane of the thin film transistor, it is possible to enable the top and bottom emission of the organic light emitting diode.

In addition, since the touch electrode is located in the backplane of the thin film transistor, it is possible to enable double-sided touch.

In addition, it is possible to implement process optimization by reducing the touch cost and the production energy.

In addition, since the large parasitic capacitance between the touch electrode and the display electrode does not need to be filled, it is possible to reduce the consumed power, thereby implementing low power.

Specific effects together with the above-described effects are described together with a description of the following detailed matters for carrying out the disclosure.

Although the present disclosure has been described above with reference to exemplary drawings, the present disclosure is not limited by the embodiments and drawings disclosed in the specification, and it is apparent that various modifications can be made by those skilled in the art within the scope of the technical spirit of the present disclosure. In addition, even when the operational effects according to the configuration of the present disclosure have not been explicitly described in the description of the embodiments of the present disclosure, it goes without saying that the effects predictable by the corresponding configuration should be recognized.

What is claimed is:

1. An in-cell touch display device comprising:
a substrate;
a transistor formation layer on the substrate, the transistor formation layer including a semiconductor, a source electrode, a drain electrode, and a gate electrode; and
a light emitting element layer on the transistor formation layer, the light emitting element layer including an anode electrode, an emission layer, and a cathode electrode,
wherein a plurality of touch electrodes that collectively form a coupling capacitor with the cathode electrode of the light emitting element layer are in the transistor formation layer.

2. The in-cell touch display device of claim 1, wherein a cover layer is on the light emitting element layer, and when a touch object touches the cover layer, an object capacitor is formed between the touch object and the cathode electrode.

3. The in-cell touch display device of claim 2, further comprising:
a sensing circuit configured to sense changes in capacitances of the object capacitor and the coupling capacitor through a touch electrode from the plurality of touch electrodes when the touch object touches the cover layer.

4. The in-cell touch display device of claim 3, wherein the sensing circuit includes:
a first integrator configured to primarily integrate a signal output from the touch electrode; and
a second integrator configured to secondarily integrate the signal integrated by the first integrator.

5. The in-cell touch display device of claim 4, wherein the first integrator includes:
a first operational amplifier having a first input terminal configured to receive an output signal of the touch electrode and a second input terminal to which a reference voltage is applied; and
a first feedback capacitor connected between the first input terminal and an output terminal of the first operational amplifier.

6. The in-cell touch display device of claim 5, wherein the second integrator includes:
a second operational amplifier having a third input terminal electrically connected to the output terminal of the first operational amplifier and a fourth input terminal to which the reference voltage is applied; and
a second feedback capacitor connected between the third input terminal and an outer terminal of the second operational amplifier.

7. The in-cell touch display device of claim 6, wherein during a touch time, a touch drive signal having a predetermined cycle and amplitude is applied to the touch electrode, a low potential modulation voltage having a same cycle and amplitude as the touch drive signal is applied to the cathode electrode, and the reference voltage having the same cycle and amplitude as the touch drive signal is applied to the second input terminal of the first operational amplifier and the fourth input terminal of the second operational amplifier.

8. The in-cell touch display device of claim 1, wherein the plurality of touch electrodes are on the substrate in the transistor formation layer, are disposed on same layer as the gate electrode or on same layer as the source electrode and the drain electrode, and are formed as a transparent electrode.

9. The in-cell touch display device of claim 1, further comprising:
a touch line in the transistor formation layer, the touch line electrically connected to a touch electrode from the plurality of touch electrodes.

10. The in-cell touch display device of claim 9, wherein the touch line is formed on the same layer the source electrode and the drain electrode of the transistor formation layer.

11. The in-cell touch display device of claim 9, wherein the touch line is disposed in a direction parallel to a data line and is on a different layer from the source electrode and the drain electrode of the transistor formation layer.

12. The in-cell touch display device of claim 1, wherein during a touch time, a touch drive signal having a predetermined cycle and amplitude is applied to a touch electrode from the plurality of touch electrodes, and a low potential modulation voltage having a same cycle and amplitude as the touch drive signal is applied to the cathode electrode.

13. An in-cell touch display device comprising:
a display panel including a plurality of sub-pixels having a light emitting element and a thin film transistor, and a plurality of touch electrodes in a transistor formation layer that includes the thin film transistor and form a coupling capacitor with a cathode electrode of the light emitting element, the cathode electrode being disposed above the plurality of touch electrodes; and
a sensing circuit configured to sense a touch signal by primarily integrating a signal output from a touch electrode from the plurality of touch electrodes and secondarily integrating the integrated signal.

14. The in-cell touch display device of claim 13, wherein the sensing circuit includes:
a first integrator configured to primarily integrate a signal output from the touch electrode; and
a second integrator configured to secondarily integrate the signal integrated by the first integrator.

15. The in-cell touch display device of claim 14, wherein the first integrator includes:
a first operational amplifier having a first input terminal configured to receive an output signal of the touch electrode and a second input terminal to which a reference voltage is applied; and
a first feedback capacitor connected between the first input terminal and an output terminal of the first operational amplifier.

16. The in-cell touch display device of claim 15, wherein the second integrator includes:
a second operational amplifier having a third input terminal electrically connected to the output terminal of the first operational amplifier and a fourth input terminal to which the reference voltage is applied; and
a second feedback capacitor connected between the third input terminal and an outer terminal of the second operational amplifier.

17. The in-cell touch display device of claim 16, wherein during a touch time, a touch drive signal having a predetermined cycle and amplitude is applied to the touch electrode, a low potential modulation voltage having a same cycle and amplitude as the touch drive signal is applied to the cathode electrode, and the reference voltage having the same cycle and amplitude as the touch drive signal is applied to the second input terminal of the first operational amplifier and the fourth input terminal of the second operational amplifier.

18. The in-cell touch display device of claim 13, wherein the display panel includes:
a substrate;
the transistor formation layer on the substrate, the transistor formation layer including a semiconductor, a source electrode, a drain electrode, and a gate electrode;
a light emitting element layer on the transistor formation layer, the light emitting element layer including an anode electrode, an emission layer, and the cathode electrode; and
a cover layer on the light emitting element layer, the cover layer having an object capacitor between a touch object and the cathode electrode when the touch object touches the cover layer, and
wherein the plurality of touch electrodes are in the transistor formation layer and collectively form the coupling capacitor with the cathode electrode of the light emitting element layer.

19. The in-cell touch display device of claim 18, wherein the sensing circuit senses changes in capacitances of the object capacitor and the coupling capacitor through at least one integrator when the touch object touches the cover layer.

20. The in-cell touch display device of claim 18, wherein the touch electrode is on the substrate in the transistor formation layer, and is disposed on same layer as the gate electrode or on same layer as the source electrode and the drain electrode.
